(19) United States
(12) Patent Application Publication
(10) Pub. No.: US 2003/0121034 A1
(43) Pub. Date: Jun. 26, 2003

(54) Television broadcast receiving apparatus and its control method

(76) Inventor: Satoru Naka, Fukaya-shi (JP)

Correspondence Address: PILLSBURY WINTHROP, LLP, P.O. BOX 10500, MCLEAN, VA, 22102, US

(21) Appl. No.: 10/096,106

(22) Filed: Mar. 13, 2002

(30) Foreign Application Priority Data
Dec. 21, 2001 (JP) 2001-390105

(51) Int. Cl. H04N 7/16; H04H 9/00

(52) U.S. Cl. 725/25; 725/10; 725/29

(57) ABSTRACT

A television broadcast receiving apparatus for comparing V-Chip rating information appended to received program information, and pre-set rating information to limit viewing of the received program, can record rating information appended to tuned program information, and program title information, in correspondence with each other, and can display a list of recorded information.

### CROSS-REFERENCE TO RELATED APPLICATIONS

This application is based upon and claims the benefit of priority from the prior Japanese Patent Application No. 2001-390105, filed Dec. 21, 2001, the entire contents of which are incorporated herein by reference.

### BACKGROUND OF THE INVENTION

1. Field of the Invention

The present invention relates to a television broadcast receiving apparatus and its control method and, more particularly, to an improvement in the setup of the rating of V-Chip as viewing limiting information.

2. Description of the Related Art

As is well known, V-Chip rating information is appended to television program information to be broadcasted in television broadcast. A television broadcast receiver compares the received V-Chip rating information with the rating which is set in advance by the user to limit viewing of television programs.

Upon setting the V-Chip rating in the television broadcast receiver, the user must select items and levels to be described below.

More specifically, there are seven types of items: 1. DIALOG, 2. LANGUAGE, 3. SEX, 4. VIOLENCE, 5. NO DLSV, 6. YOUTH TV RATING, and 7. MAPP RATING. Each of items 1 to 5 has four levels: MA, 14, PG, and G, item 6 has three levels: Y7FV, Y7, and Y, and item 7 has six levels: X, NC17, R, PG13, PG, and G.

In this way, upon setting the V-Chip rating, the user must select items and their levels. However, since the user can hardly recognize the relationship between actual program contents and levels especially upon selecting levels, it is difficult to select optimal levels.

As prior art that pertains to V-Chip rating setting, for example, Jpn. Pat. Appln. KOKAI Publication No. 2000-244830 is known. With this technique, a remote controller checks the user's fingerprint, and if that fingerprint is the one which is registered in advance, the user is allowed to change the rating setup. However, this reference does not describe selection of an optimal level.

### BRIEF SUMMARY OF THE INVENTION

The present invention has been made in consideration of the above situation, and has as its object to provide a television broadcast receiving apparatus which allows the user to easily set an optimal rating of V-Chip, and its control method.

According to one aspect of the present invention, there is provided a television broadcast receiving apparatus for comparing viewing limitation information appended to received program information, and pre-set setting information to limit viewing of the received program, comprising:

a recording unit configured to record viewing limitation information appended to tuned program information, and information that specifies the program, in correspondence with each other; and

a display unit configured to display a list of information recorded in the recording unit.

According to another aspect of the present invention, there is provided a method of controlling a television broadcast receiving apparatus for comparing viewing limitation information appended to received program information, and pre-set setting information to limit viewing of the received program, comprising:

recording viewing limitation information appended to tuned program information, and information that specifies the program, in correspondence with each other; and

displaying a list of the recorded information.

With this arrangement and method, since information that specifies the previously tuned program and viewing limitation information appended to that program are recorded in correspondence with each other, and can be displayed as a list, the user can easily recognize the correspondence between the actual program contents and levels. Hence, the user can easily select an optimal level, thus making user's handling convenient, and effectively promoting practical use.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram for explaining a television broadcast receiver according to an embodiment of the present invention;

FIG. 2 is a flow chart for explaining the operation for recording rating information, program title information, and the like in a memory in the embodiment; and

FIGS. 3A and 3B are views for respectively explaining a list display window of rating information, program title information, and the like, and a rating setting window in the embodiment.

### DETAILED DESCRIPTION OF THE INVENTION

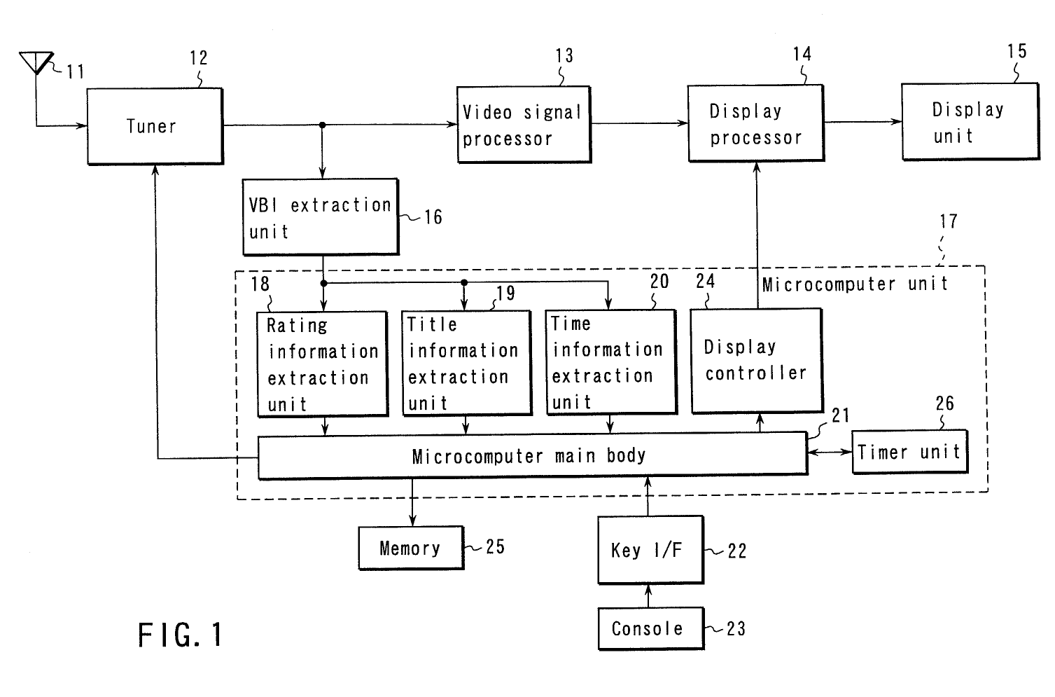

An embodiment of the present invention will be described in detail hereinafter with reference to the accompanying drawings. FIG. 1 schematically shows a television broadcast receiver to be explained in this embodiment. A television broadcast wave received by an antenna 11 is supplied to a tuner 12 to tune a television signal of a desired channel.

The television signal tuned by the tuner 12 undergoes predetermined signal processes respectively in a video signal processor 13 and display processor 14, and the processed signal is then supplied to a display unit 15, thus displaying an image.

The television signal tuned by the tuner 12 is supplied to a VBI (Vertical Blanking Interval) extraction unit 16, which extracts digital information multiplexed on the vertical blanking interval of the television signal.

The digital information extracted by the VBI extraction unit 16 is respectively supplied to a rating information extraction unit 18, title information extraction unit 19, and time information extraction unit 20, which form a microcomputer unit 17.

Of these units, the rating information extraction unit 18 extracts V-Chip rating information from the input digital information, and outputs it to a microcomputer main body 21.

The title information extraction unit 19 extracts program title information from the input digital information, and outputs it to the microcomputer main body 21. Furthermore, the time information extraction unit 20 extracts time information from the input digital information, and outputs it to the microcomputer main body 21.

The microcomputer main body 21 controls tuning of the tuner 12 and the display processor 24 via a display controller 24 upon receiving operation information from a console 23, which is input via a key I/F (Inter/Face) 22.

The microcomputer main body 21 records the information extracted by the rating information extraction unit 18, title information extraction unit 19, and time information extraction unit 20 in a nonvolatile memory 25. Furthermore, the microcomputer main body 21 is connected to a timer unit 26, and can measure time.

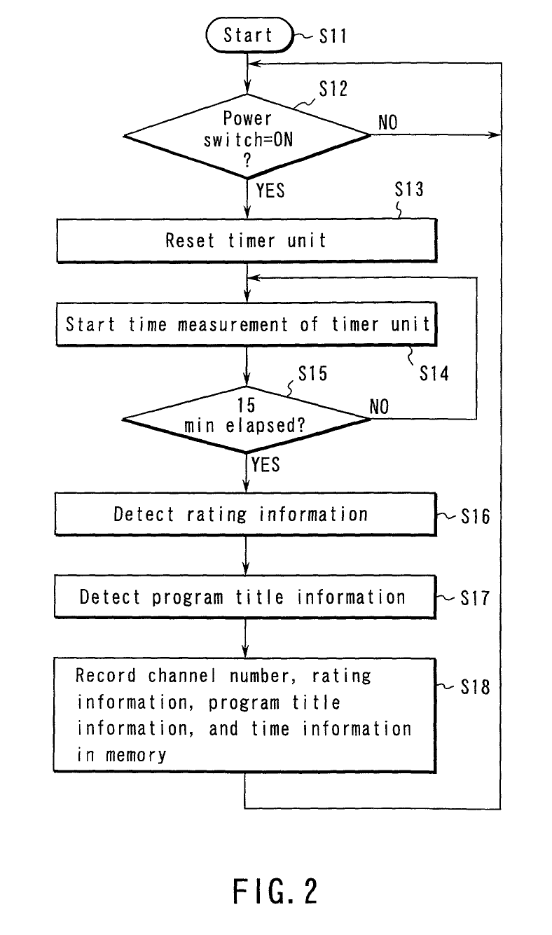

The operation of the television broadcast receiver with the above arrangement will be described below with reference to the flow chart shown in FIG. 2. If the process starts (step S11), the microcomputer main body 21 checks in step S12 if a power switch of the console 23 is turned on.

If it is determined that the power switch is turned on (YES in step S12), the microcomputer main body 21 resets the timer unit 26 in step S13, makes the timer unit 26 to start a time measurement operation in step S14, and checks in step S1S if 15 minutes have elapsed.

If it is determined that 15 minutes have not elapsed yet (NO in step S15), the flow returns to the process in step S13; otherwise (YES in step S15), the microcomputer main body 21 detects rating information extracted by the rating information extraction unit 18 in step S16, and detects program title information extracted by the title information extraction unit 19 in step S17.

After that, the microcomputer main body 21 records the number of the currently tuned channel, the previously detected rating information and program title information, and time information extracted by the time information extraction unit 20 in the memory 25 in step S18, and the flow returns to the process in step S12.

With the aforementioned operation, the number of a channel to which the user is tuned at that time, and rating information, program title information and time information, which are multiplexed on the television signal of that channel, are stored in the memory 25 at 15-min intervals.

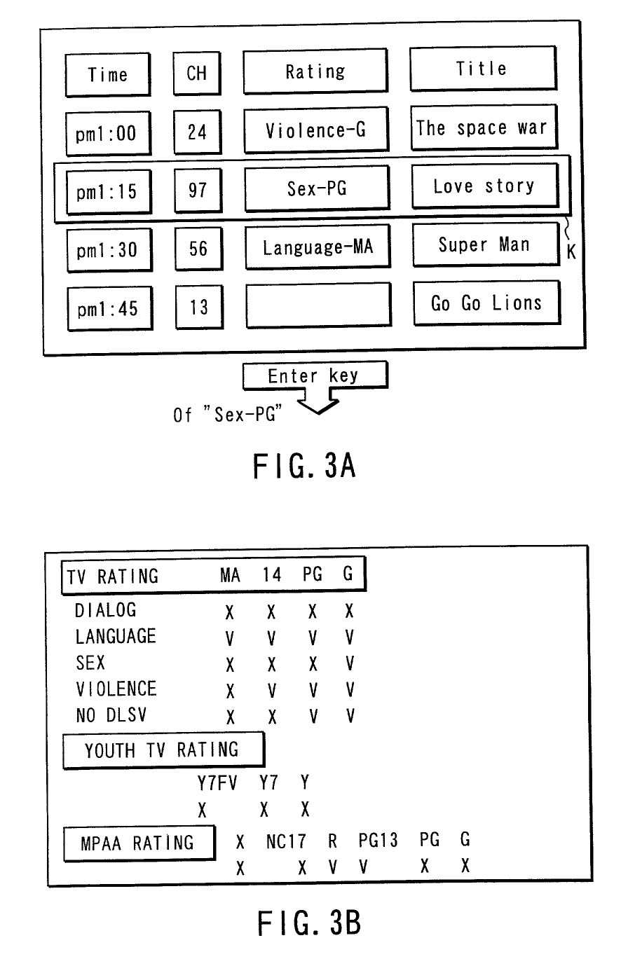

Upon setting the V-Chip rating, the user operates the console 23 to display a list of various kinds of information stored in the memory 25 on the display unit 15, as shown in FIG. 3A. In this case, the list display window displays the times, channel numbers, ratings, and titles of programs that the user viewed previously in ascending order of time.

The user selects the rating with reference to those appended to the programs he or she tuned previously, which are displayed on the list display window. For example, assume that the user does not want a child to view a program with a level corresponding to a program “Love Story” he or she viewed previously in association with the item “SEX”.

The user the operates the console 23 to select the rating of “Love Story” from those displayed in the list using cursor K, and then operates an enter key of the console 23. In this way, the display contents on the display unit 15 are switched to a rating setting window shown in FIG. 3B, and the user can confirm that the item “SEX” is automatically set to be level “PG”.

According to the embodiment mentioned above, since the title information of each program the user previously tuned to (viewed), and rating information appended to that program are stored in the memory 25 in correspondence with each other, and can be displayed in a list, the user can easily recognize the correspondence between actual program contents and levels, thus easily selecting an optimal level.

Also, when the user selects a desired title from the program titles displayed in a list using cursor K, and operates the enter key of the console 23, that rating is automatically set. Hence, when the same rating as that of the program the user viewed previously is to be set, the setting operation is facilitated. Furthermore, after the same rating as that of the program the user viewed previously is set, the user can change the level by operating the console 23.

In the above embodiment, the title information of a tuned program and rating information appended to that program are stored in the memory 25 in correspondence with each other at 15-min intervals. Alternatively, such information may be recorded in the memory 25, e.g., when the program title is switched or another channel is selected.

Furthermore, the memory 25 need not record the program title information, but need only record information that can specify a program and allows the user to remind the program contents (e.g., a broadcast time, channel number, or the like).

Note that the present invention is not limited to the above embodiment, and various modifications may be made without departing from the scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A television broadcast receiving apparatus for comparing viewing limitation information appended to received program information, and pre-set setting information to limit viewing of the received program, comprising:
a recording unit configured to record viewing limitation information appended to tuned program information, and information that specifies the program, in correspondence with each other; and
a display unit configured to display a list of information recorded in said recording unit.

2. The apparatus according to claim 1, wherein said recording unit records the viewing limitation information appended to tuned program information, and the information that specifies the program, every time a predetermined period of time elapses.

3. The apparatus according to claim 1, wherein said recording unit records the viewing limitation information appended to tuned program information, and the information that specifies the program, every time program information to which the user is tuned is changed.

4. The apparatus according to claim 1, wherein said recording unit records the viewing limitation information extracted from a vertical blanking interval of a tuned television signal.

5. The apparatus according to claim 1, further comprising:
a selection unit configured to select the viewing limitation information displayed in a list on said display unit; and
a setting unit configured to automatically set the setting information on the basis of the viewing limitation information selected by said selection unit.

6. The apparatus according to claim 5, further comprising:
a console configured to change the setting information set by said setting unit.

7. The apparatus according to claim 1, wherein the viewing limitation information is V-Chip rating information multiplexed on a vertical blanking interval of a television signal.

8. A television broadcast receiving apparatus for comparing viewing limitation information appended to received program information, and pre-set setting information to limit viewing of the received program, comprising:
means for recording viewing limitation information appended to tuned program information, and information that specifies the program, in correspondence with each other; and
means for displaying a list of information recorded in said means for recording.

9. The apparatus according to claim 8, further comprising:
means for selecting the viewing limitation information displayed in a list on said means for displaying; and
means for automatically setting the setting information on the basis of the viewing limitation information selected by said means for selecting.

10. The apparatus according to claim 9, further comprising:
means for changing the setting information set by said means for setting.

11. A method of controlling a television broadcast receiving apparatus for comparing viewing limitation information appended to received program information, and pre-set setting information to limit viewing of the received program, comprising:
recording viewing limitation information appended to tuned program information, and information that specifies the program, in correspondence with each other; and
displaying a list of the recorded information.

12. The method according to claim 11, wherein the viewing limitation information appended to tuned program information, and the information that specifies the program are recorded every time a predetermined period of time elapses.

13. The method according to claim 11, wherein the viewing limitation information appended to tuned program information, and the information that specifies the program are recorded every time program information to be tuned is changed.

14. The method according to claim 11, further comprising:
selecting the viewing limitation information displayed in a list; and
automatically setting the setting information on the basis of the selected viewing limitation information.

15. The method according to claim 14, further comprising:
changing the automatically set setting information.

16. A method of controlling a television broadcast receiving apparatus for comparing viewing limitation information appended to received program information, and pre-set setting information to limit viewing of the received program, comprising:
recording viewing limitation information appended to tuned program information, and information that specifies the program, in correspondence with each other;
displaying a list of information recorded in the recorded information;
selecting the viewing limitation information displayed in a displayed list; and
automatically setting the setting information on the basis of the viewing limitation information selected.

17. The method according to claim 16, further comprising:
changing the setting information set.
